(19) United States
(12) Patent Application Publication
(10) Pub. No.: US 2023/0407105 A1
(43) Pub. Date: Dec. 21, 2023

(54) WATER-BASED HEAVY-DUTY ANTI-CORROSION COATING STRUCTURE AND MANUFACTURING METHOD THEREOF

(71) Applicant: KJ Applied Material Co., Ltd., Taichung City (TW)

(72) Inventors: CHIH-JUNG WU, Taichung City (TW); CHUAN-HSU TSAI, Taichung City (TW)

(21) Appl. No.: 17/835,646

(22) Filed: Jun. 8, 2022

(51) Int. Cl. C09D 5/08; C09D 7/20; C09D 7/40; B05D 1/02

(52) U.S. Cl. CPC C09D 5/08; B05D 1/02; C09D 7/40; C09D 7/20

(57) ABSTRACT

The present invention provides a water-based heavy-duty anti-corrosion coating structure and manufacturing method thereof. The structure includes a base material and a water-based coating. The base material includes a surface. A water-based coating material is sprayed on the surface of the base material to form the water-based coating. The water-based coating material includes a water-based polymer resin, a film-forming auxiliary, an auxiliary, a water-based color paste, and a deionized water. Therein, by weight percentage, the coating material comprises 40% to 60% of water-based polymer resin, 10% to 20% of film-forming auxiliary, 1% to 2% of auxiliary, 5% to 16% of water-based color paste, and 20% to 40% of deionized water. Therefore, the volatile organic compounds (VOC) content of the coating material is effectively reduced, and an excellent anti-corrosion property is provided.

### BACKGROUND OF THE INVENTION

### 1. Field of the Invention

The present invention relates to coating material fields, and more particularly, to a heavy-duty anti-corrosion coating structure and manufacturing method thereof.

### 2. Description of the Related Art

As many countries are paying much attention to the research on anti-corrosion materials, anti-corrosion coating material is one of the most effective methods among other anti-corrosion measures. Therein, the heavy-duty anti-corrosion coating material is the most representative and influential among them, and also the most promising type of protective coating materials.

The heavy-duty anti-corrosion coating material is allowed to be used under relatively harsh environmental conditions. In addition to a long-term anti-corrosion service life, it is also applicable in chemical industrial atmosphere and marine environments. However, due to the needs of environmental protection, many countries have begun to reduce volatile organic compounds (VOC) in the coating material. The conventional anti-corrosion coating materials volatilize organic solvents and generate a large number of pores during film formation, which causes environmental pollution. Also, the pores allow the penetration of water, oxygen, and other corrosive gases, such that the anti-corrosion effect is compromised.

### SUMMARY OF THE INVENTION

To improve the issues above, the present invention discloses a water-based heavy-duty anti-corrosion coating structure and manufacturing method thereof, which effectively lower the VOC content of the coating material and provide an optimal anti-corrosion performance.

For achieving the aforementioned objectives, the present invention provides a water-based heavy-duty anti-corrosion coating structure, comprising a base material and a water-based coating. The base material comprising a surface. A water-based coating material is sprayed on the surface of the base material to form the water-based coating. The water-based coating material comprises a water-based polymer resin, a film-forming auxiliary, an auxiliary, a water-based color paste, and a deionized water. Therein, by weight percentage, the coating material comprises 40% to 60% of water-based polymer resin, 10% to 20% of film-forming auxiliary, 1% to 2% of auxiliary, 5% to 16% of water-based color paste, and 20% to 40% of deionized water.

In an embodiment of the present invention, the film-forming auxiliary is cetyl alcohol, dipropylene glycol methyl ether, dipropylene glycol butyl ether, or a combination thereof.

In an embodiment of the present invention, the auxiliary is sheetlike silicate dispersion, bentonite, or a combination thereof.

In an embodiment of the present invention, the water-based color paste is a white color paste, black color paste, red color paste, yellow color paste, blue color paste, and green color paste or a combination thereof.

In an embodiment of the present invention, the wet film thickness of the water-based coating is 100 μm to 300 μm.

In an embodiment of the present invention, the viscosity of the coating material is 6 Pa·s to 8 Pa·s.

In an embodiment of the present invention, the water-based coating material is contained in the spray can device, so as to be sprayed on the base material to form the water-based coating.

The present invention provides manufacturing method of a water-based heavy-duty anti-corrosion coating structure, comprising following steps: step S1, blending a water-based polymer resin and a film-forming auxiliary under a first condition; step S2, adding an auxiliary and a deionized water and blending under a second condition; step S3, adding a water-based color paste and blending under a third condition to form a mixture; step S4, filtering the mixture to obtain a water-based coating material; and step S5, spraying the water-based coating material on a base material to form a water-based coating.

In an embodiment of the present invention, in step S1, the first condition is a blending speed being 600 to 800 rpm and a blending time being 60 minutes.

In an embodiment of the present invention, in step S2, the second condition is a blending speed being 600 to 800 rpm and a blending time being 60 minutes.

In an embodiment of the present invention, in step S3, the third condition is a blending speed being 600 to 800 rpm and a blending time being 30 minutes.

In an embodiment of the present invention, in step S4, the mixture is filtered through a 200-mesh filter screen.

With such configuration, the water-based coating material of the present invention has excellent chemical resistance, aging resistance, and wrapping property, effectively improving the high VOC content issue of the conventional anti-corrosion coating material, thereby realizing the concept of water-based environmental protection and providing excellent anti-corrosion performance. Thus, the present invention is applicable in heavy-duty anti-corrosion fields such as chemical industrial atmosphere and marine environment.

### BRIEF DESCRIPTION OF THE DRAWINGS

FIG. 1 is a sectional view of the water-based coating structure in accordance with the present invention.

FIG. 2 is a schematic view of the present invention illustrating the water-based coating material being sprayed on the base material.

FIG. 3 is a block view illustrating the manufacturing process of the water-based coating structure.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

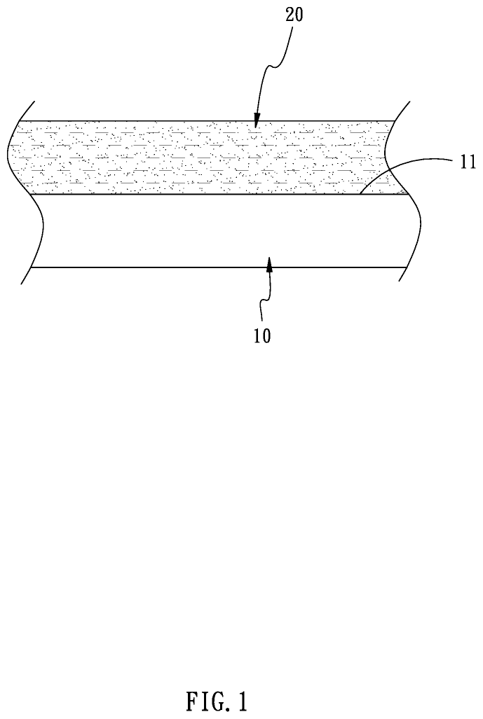

Referring to FIG. 1 to FIG. 3, the present invention provides a water-based heavy-duty anti-corrosion coating structure and manufacturing method thereof.

The water-based coating structure comprises a base material 10 and a water-based coating 20. Therein, a water-based coating material is sprayed on the base material 10 for wrapping the base material 10 to form the water-based coating 20, thereby providing an optimal anti-corrosion performance to be applied in heavy-duty anti-corrosion field.

The base material 10 comprises a surface 11. The water-based coating 20 evenly wraps the surface 11 of the base material 10. In the embodiment, the base material 10 is a metal, plastic, rubber, concrete, cement, asphalt, paper, textile, wood, ceramic tile, or glass.

The water-based coating material comprises a water-based polymer resin, a film-forming auxiliary, an auxiliary, a water-based color paste, and a deionized water.

In the embodiment, the wet film thickness of the water-based coating material is 100 μm to 300 μm. Preferably, the wet film thickness is 150 μm. For further information, the conventional water-based coating material wet film has a sagging issue when the thickness thereof reaches 40 μm to 50 μm. To reach a thickness of coating larger than 300 μm, the coating process needs to be carried out for more than ten times. In contrast, the water-based coating material of the present invention is allowed to reach a thickness of 150 μm with only a single coating process. After repeating two to three times of coating processes, a heavy-duty anti-corrosion demand is met, thereby realizing higher convenience and economic benefits.

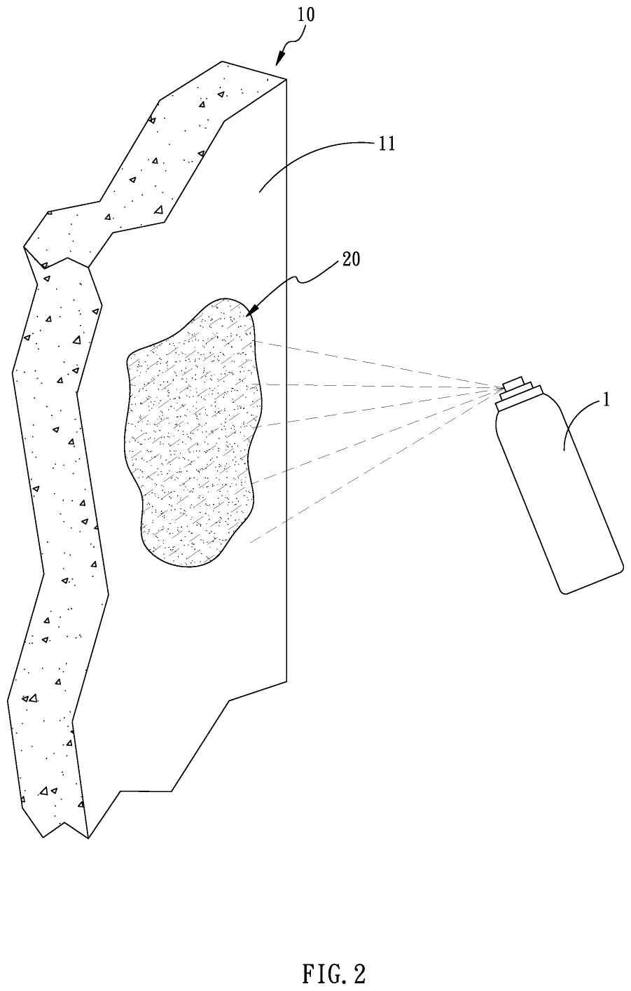

As shown by FIG. 2, in the embodiment, the water-based coating material is contained in the spray can device 1, so as to be sprayed on the surface 11 of the base material 10 to form the water-based coating 20.

In the embodiment, by weight percentage, the coating material comprises 40% to 60% of water-based polymer resin, 10% to 20% of film-forming auxiliary, 1% to 2% of auxiliary, 5% to 16% of water-based color paste, and 20% to 40% of deionized water.

The water-based polymer resin has excellent chemical resistance and aging resistance, so as to be suitable for application in fields needing heavy-duty anti-corrosion performance. Also, the water-based polymer resin has high stability and solvent wrapping property, effectively improving the high VOC content issue of the conventional anti-corrosion coating material.

The film-forming auxiliary causes a dissolving and swelling effects upon the polymer particles, so that the particles undergo a plastic flowing and elastic deformation along with the volatilization of water to aggregate into a film even at a lower temperature. Also, the film undergoes a volatilization and escaping process in a short time after the formation thereof. Further, the plastic flowing and elastic deformation of latex particles are promoted, and the aggregation thereof is improved, so as to form the film in a wide range of construction temperatures.

In an embodiment of the present invention, the film-forming auxiliary is cetyl alcohol, dipropylene glycol methyl ether, dipropylene glycol butyl ether, or a combination thereof.

The auxiliary improves the viscosity and suspension property of the coating material, enhancing the sedimentation preventing ability. Also, the auxiliary improves covering capability, scrub resistance, and water resistance of the coating material.

In an embodiment of the present invention, the auxiliary is sheetlike silicate dispersion, bentonite, or a combination thereof.

The water-based color paste, in comparison with conventional pigment powder, has optimal color reproducibility, color presenting property, optimal compatibility, and thixotropic fluidity. After the film formation, the coating material processes great light fastness and weather resistance, so as to prevent colors from fading.

In an embodiment of the present invention, the water-based color paste is a white color paste, black color paste, red color paste, yellow color paste, blue color paste, and green color paste or a combination thereof.

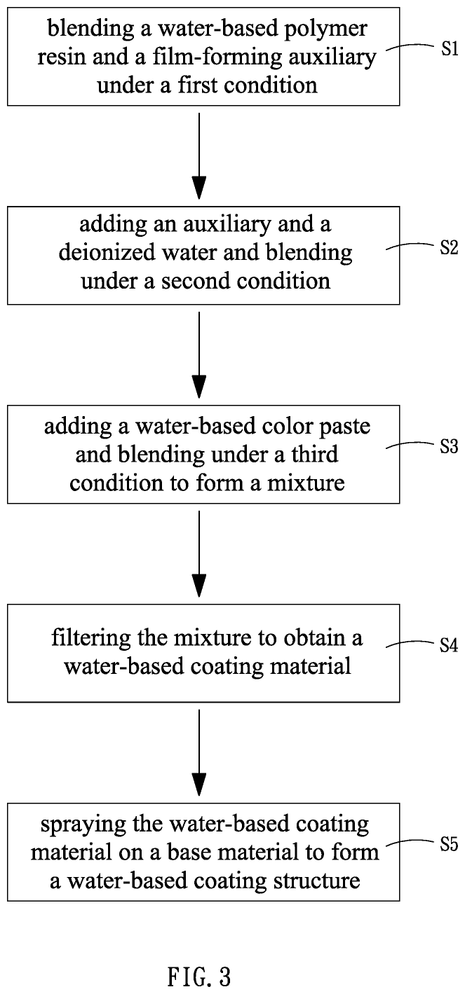

Referring to FIG. 3, the manufacturing method of the water-based heavy-duty anti-corrosion coating structure comprises steps S1, S2, S3, S4, and S5.

In step S1, the water-based polymer resin and the film-forming auxiliary are blended under a first condition, wherein the first condition is the blending speed being 600 to 800 rpm and the blending time being 60 minutes.

In step S2, the auxiliary and the deionized water are added to be blended with foregoing materials under a second condition, wherein the second condition is the blending speed being 600 to 800 rpm and the blending time being 60 minutes.

In step S3, the water-based color paste is added to be blended with foregoing materials under a third condition to form a mixture, wherein the third condition is the blending speed being 600 to 800 rpm and the blending time being 30 minutes.

In step S4, the mixture is filtered through a 200-mesh filter screen to obtain the water-based coating material.

In step S5, the water-based coating material is sprayed on the base material 10 to form the water-based coating 20.

The present invention will be described in detail below through following embodiments.

### Embodiment 1

In step S1, 500 kilograms of water-based polymer resin and 80 kilograms of film-forming auxiliary are evenly mixed at a blending speed of 600 to 800 rpm for 60 minutes. In step S2, 2 kilograms of auxiliary and 300 kilograms of deionized water are added to be evenly mixed at a blending speed of 600 to 800 rpm for 60 minutes. In step S3, 5 kilograms of water-based color paste is added to be evenly mixed at a blending speed of 600 to 800 rpm for 30 minutes to obtain a mixture. In step S4, the mixture is filtered through a 200-mesh filter screen to obtain a water-based coating material. In step S5, the water-based material is contained in the spray can device 1 to be sprayed on the base material 10 to form the water-based coating 20.

Test results of the property of the water-based coating material in accordance with the embodiment 1 are listed in the following table:

| No. | Items | Index |
|---|---|---|
| 1 | Maximum tolerance limit (g/L) of | 24 |
| | volatile organic compounds (VOC) | |
| 2 | Adherence (grid attachment method for | 10 points |
| | 100 grids) | |
| | Impact resistance (punch head diameter: | No cracks, |
| 3 | 12.7 mm, hammer weight: 500 g, | no peeling |
| | punching height: 500 mm) | off |
| 4 | Salted water resistance (5 w/v % sodium | No |
| | chloride solution, 840 hrs) | abnormality |
| 5 | Alkali resistance (50 g/L sodium | No |
| | hydroxide solution, 23 ± 2° C., 500 hrs) | abnormality |
| | Acid resistance (50 g/L sulfuric acid | No |
| | solution, 23 ± 2° C., 500 hrs) | abnormality |
| 6 | Salted water spraying test (50 ± 10 g/L | No |
| | sodium chloride solution, 35 ± 2° C., 1440 | abnormality |
| | hrs) | |

In the embodiment, the viscosity of the water-based coating material measured by a digital viscometer is 6 to 8 Pa·s.

### Embodiment 2

In step S1, 300 kilograms of water-based polymer resin and 48 kilograms of film-forming auxiliary are evenly mixed at a blending speed of 600 to 800 rpm for 60 minutes. In step S2, 1 kilograms of auxiliary and 200 kilograms of deionized water are added to be evenly mixed at a blending speed of 600 to 800 rpm for 60 minutes. In step S3, 3 kilograms of water-based color paste is added to be evenly mixed at a blending speed of 600 to 800 rpm for 30 minutes to obtain a mixture. In step S4, the mixture is filtered through a 200-mesh filter screen to obtain a water-based coating material. In step S5, the water-based material is contained in the spray can device 1 to be sprayed on the base material 10 to form the water-based coating 20.

Test results of the property of the water-based coating material in accordance with the embodiment 2 are listed in the following table:

| No. | Items | Index |
|---|---|---|
| 1 | Maximum tolerance limit (g/L) of | 44 |
| | volatile organic compounds (VOC) | |
| 2 | Adherence (grid attachment method for | 10 points |
| | 100 grids) | |
| 3 | Impact resistance (punch head diameter: | No cracks, |
| | 12.7 mm, hammer weight: 500 g, | no peeling |
| | punching height: 500 mm) | off |
| 4 | Salted water resistance (5 w/v % sodium | No |
| | chloride solution, 840 hrs) | abnormality |
| 5 | Alkali resistance (50 g/L sodium | No |
| | hydroxide solution, 23 ± 2° C., 500 hrs) | abnormality |
| | Acid resistance (50 g/L sulfuric acid | No |
| | solution, 23 ± 2° C., 500 hrs) | abnormality |
| 6 | Salted water spraying test (50 ± 10 g/L | No |
| | sodium chloride solution, 35 ± 2° C., 1440 | abnormality |
| | hrs) | |

In the embodiment, the viscosity of the water-based coating material measured by a digital viscometer is 6 to 8 Pa·s.

According to the water-based coating material property test results above, the VOC content of the water-based coating material is lower than 50 g/L. Also, the water-based coating material has excellent chemical resistance and aging resistance, so as to be suitable for application in heavy-duty anti-corrosion field. Further, the salted water spraying resistance is larger than 1440 hours.

Therefore, the water-based coating 20 of the water-based coating structure of the present invention has excellent chemical resistance, aging resistance, and wrapping property, effectively improving the high VOC content issue of the conventional anti-corrosion coating material, thereby realizing the concept of environmental protection and providing excellent anti-corrosion and restoration performance. Thus, the present invention is applicable in heavy-duty anti-corrosion fields such as chemical industrial atmosphere and marine environment.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A water-based heavy-duty anti-corrosion coating structure, comprising a base material and a water-based coating, the base material comprising a surface, a water-based coating material being sprayed on the surface of the base material to form the water-based coating, the water-based coating material comprising a water-based polymer resin, a film-forming auxiliary, an auxiliary, a water-based color paste, and a deionized water;
wherein, the water-based polymer resin accounts for 40% to 60% by weight of the water-based coating material, the film-forming auxiliary accounts for 10% to 20% by weight of the water-based coating material, the auxiliary accounts for 1% to 2% by weight of the water-based coating material, the water-based color paste accounts for 5% to 16% by weight of the water-based coating material, and the deionized water accounts for 20% to 40% by weight of the water-based coating material.

2. The water-based heavy-duty anti-corrosion coating structure of claim 1, wherein the film-forming auxiliary is selected from a group consisting of cetyl alcohol, dipropylene glycol methyl ether, dipropylene glycol butyl ether, and a combination thereof.

3. The water-based heavy-duty anti-corrosion coating structure of claim 1, wherein the auxiliary is selected from a group consisting of sheetlike silicate dispersion, bentonite, and a combination thereof.

4. The water-based heavy-duty anti-corrosion coating structure of claim 1, wherein the water-based color paste is selected from a group consisting of white color paste, black color paste, red color paste, yellow color paste, blue color paste, and green color paste or a combination thereof.

5. The water-based heavy-duty anti-corrosion coating structure of claim 1, wherein a wet film thickness of the water-based coating is 100 μm to 300 μm.

6. The water-based heavy-duty anti-corrosion coating structure of claim 1, wherein a viscosity of the coating material is 6 Pa·s to 8 Pa·s.

7. The water-based heavy-duty anti-corrosion coating structure of claim 1, wherein the water-based coating material is contained in the spray can device, so as to be sprayed on the base material to form the water-based coating.

8. A manufacturing method of the water-based heavy-duty anti-corrosion coating structure of claim 1, comprising following steps:
step S1, blending a water-based polymer resin and a film-forming auxiliary under a first condition;
step S2, adding an auxiliary and a deionized water and blending materials above under a second condition;
step S3, adding a water-based color paste and blending materials above under a third condition to form a mixture;
step S4, filtering the mixture to obtain a water-based coating material; and
step S5, spraying the water-based coating material on a base material to form a water-based coating.

9. The manufacturing method of claim 8, wherein, in step S1, the first condition is a blending speed being 600 to 800 rpm and a blending time being 60 minutes.

10. The manufacturing method of claim 8, wherein, in step S2, the second condition is a blending speed being 600 to 800 rpm and a blending time being 60 minutes.

11. The manufacturing method of claim 8, wherein, in step S3, the third condition is a blending speed being 600 to 800 rpm and a blending time being 30 minutes.

12. The manufacturing method of claim 8, wherein, in step S4, the mixture is filtered through a 200-mesh filter screen.
